(19) United States
(12) Patent Application Publication
(10) Pub. No.: US 2013/0175904 A1
(43) Pub. Date: Jul. 11, 2013

(54) SWITCHED RELUCTANCE MOTOR

(71) Applicant: SAMSUNG ELECTRO-MECHANICS CO., LTD., Suwon (KR)

(72) Inventors: Su Bong Jang, Suwon (KR); Han Kyung Bae, Suwon (KR); Hee Soo Yoon, Suwon (KR); Chang Hwan Park, Suwon (KR); Sang Jong Lee, Suwon (KR); Tae Ho Yun, Suwon (KR); Jin Su Seok, Suwon (KR)

(73) Assignee: SAMSUNG ELECTRO-MECHANICS CO., LTD., Suwon (KR)

(21) Appl. No.: 13/734,342

(22) Filed: Jan. 4, 2013

(30) Foreign Application Priority Data
Jan. 6, 2012 (KR) 10-2012-0001889

(51) Int. Cl. H02K 11/00

(52) U.S. Cl. CPC H02K 11/0015
USPC 310/68 B

(57) ABSTRACT

Disclosed herein is a switched reluctance motor including: a stator; a rotor rotating based on a motor shaft with respect to the stator; a housing having a cup shape and receiving the stator and the rotor therein and including a receiving groove at a central portion of a lower surface thereof; a sensor part including a disk coupled to a predetermined position of a lower portion of the motor shaft extended up to the receiving groove and a sensor detecting a rotational state of the disk, and mounted on the outside of the housing; and filter shielding the sensor part.

### CROSS REFERENCE TO RELATED APPLICATION

This application claims the benefit of Korean Patent Application No. 10-2012-0001889, filed on Jan. 6, 2012, entitled “Switched Reluctance Motor”, which is hereby incorporated by reference in its entirety into this application.

### BACKGROUND OF THE INVENTION

1. Technical Field

The present invention relates to a switched reluctance motor.

2. Description of the Related Art

A vacuum cleaner, which is a device partially generating vacuum while converting electric energy into mechanical rotational motion to collect external dirt such as dust, or the like, includes a motor, for example, a switched reluctance motor (SRM), in order to generate the vacuum.

The switched reluctance motor used in this vacuum cleaner is disclosed in Patent Document 1.

The switched reluctance motor disclosed in Patent Document 1 includes a stator, a rotor, an impeller rotatably coupled to an upper portion of the rotor to generate suction force, and a sensor supporting member mounted on a lower portion of a motor housing, as already widely known.

In addition, the switched reluctance motor disclosed in Patent Document 1 includes the impeller at an upper portion and the sensor supporting member at a lower portion in an axial direction of the motor shaft.

The sensor supporting member is configured of a disk and a sensor, wherein the disk is formed at an outer side of the motor housing at the lower portion of the motor shaft and fixed to the motor shaft so as to be rotatable in the stator and has the same shape as that of a cross-section of the rotor perpendicular to an axial direction so as to detect a position of the rotor including a plurality of protruding salient poles. In addition, the sensor detecting rotation of the disk is provided.

However, in the switched reluctance motor according to the prior art, the sensor supporting member is coupled to the lower portion of the motor housing and has a cylindrical shape with one side opened, and a flange is provided at an edge of the sensor supporting member so as to enable area-contact between a lower surface of the motor housing and the sensor supporting member.

This sensor supporting member is mounted on the lower surface of the motor housing using various methods such as a screw fastening method, or the like.

As described above, the sensor supporting member has the cylindrical shape with one side opened, that is, a cup shape and protrudes from the motor as shown in the accompanying drawing 3 of Patent Document 1. The sensor supporting member increases the entire size of the motor, and at the time of error generation of the sensitive sensor, the sensor may be replaced after the sensor supporting member is separated from the motor housing by loosening the screw.

In addition, since the sensor supporting member has the cylindrical shape, in the case in which sealing is performed when the sensor supporting member is fixed to the lower surface of the motor, a degree of vacuum is gradually increased in the sensor supporting member by rotation of the motor shaft, such that heat exchange with the outside is not performed, thereby causing a negative effect due to an internal high temperature of the sensor supporting member.

In addition, since the sensor supporting member is fixed by the screw fastening method, whenever the sensor supporting member is separated, complicated processes of separating the screw and refastening the screw again should be performed.

Therefore, other solutions capable of solving the above-mentioned problems should be considered.

### PRIOR ART DOCUMENT

### Patent Document

(Patent Document 1) Korean Patent Laid-Open Publication No. 10-2008-0026872

### SUMMARY OF THE INVENTION

The present invention has been made in an effort to provide a switched reluctance motor capable of easily allowing air to flow while protecting a sensor part of the motor.

According to a first preferred embodiment of the present invention, there is provided a switched reluctance motor including: a stator; a rotor rotating based on a motor shaft with respect to the stator; a housing having a cup shape and receiving the stator and the rotor therein; a sensor part including a disk coupled to a predetermined position of a lower portion of the motor shaft and a sensor detecting a rotational state of the disk, and mounted on the outside of the housing; and a filter shielding the sensor part.

The sensor part may be mounted on a lower surface of the housing to detect rotation of the rotor, that is, a position.

The filter may have a mesh structure with fine pores. Therefore, inflow of foreign materials such as dust into the sensor part may be prevented, but inflow and outflow of air may be permitted.

The filter may include a screen having fine pores and a flange provided at an edge of the screen, wherein the flange surface-contacts the lower surface of the motor housing to allow the filter to be easily coupled thereto.

The filter may be made of an insulating material.

Selectively, the filter may further include a filter paper such as a non-woven fabric on the screen to perform double dustproof action together with the screen having a mesh structure.

According to a second preferred embodiment of the present invention, there is provided a switched reluctance motor including: a stator; a rotor rotating based on a motor shaft with respect to the stator; a housing having a cup shape in which the stator and the rotor are received and including a receiving groove at a central portion of a lower portion thereof; a sensor part including a disk coupled to a predetermined position of a lower portion of the motor shaft extended up to the receiving groove and a sensor detecting a rotational state of the disk, and mounted in the receiving groove of the housing; and a filter shielding the sensor part.

The filter may have a flat disk shape to close an opened part of a lower portion of the receiving groove.

The filter may have a mesh structure with fine pores. Therefore, inflow of foreign materials such as dust into the sensor part may be prevented, but inflow and outflow of air may be permitted.

Selectively, the screen may be made of a non-woven fabric.

The filter may include a screen having fine pores and a flange provided at an edge of the screen, wherein the flange surface-contacts the lower surface of the motor housing to allow the filter to be easily coupled thereto.

The filter may be made of an insulating material.

In addition, the filter may be configured of the screen having a mesh structure with fine pores and further include a filter paper such as a non-woven fabric on the screen in order to collect ultra-fine dust to perform double dustproof action together with the screen having a mesh structure.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view of a switched reluctance motor according to a preferred embodiment of the present invention;

FIG. 2 is a perspective view of the switched reluctance motor shown in FIG. 1 when viewed from below; and

FIG. 3 is a cross-sectional view showing only some components of the switched reluctance motor shown in FIG. 1.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

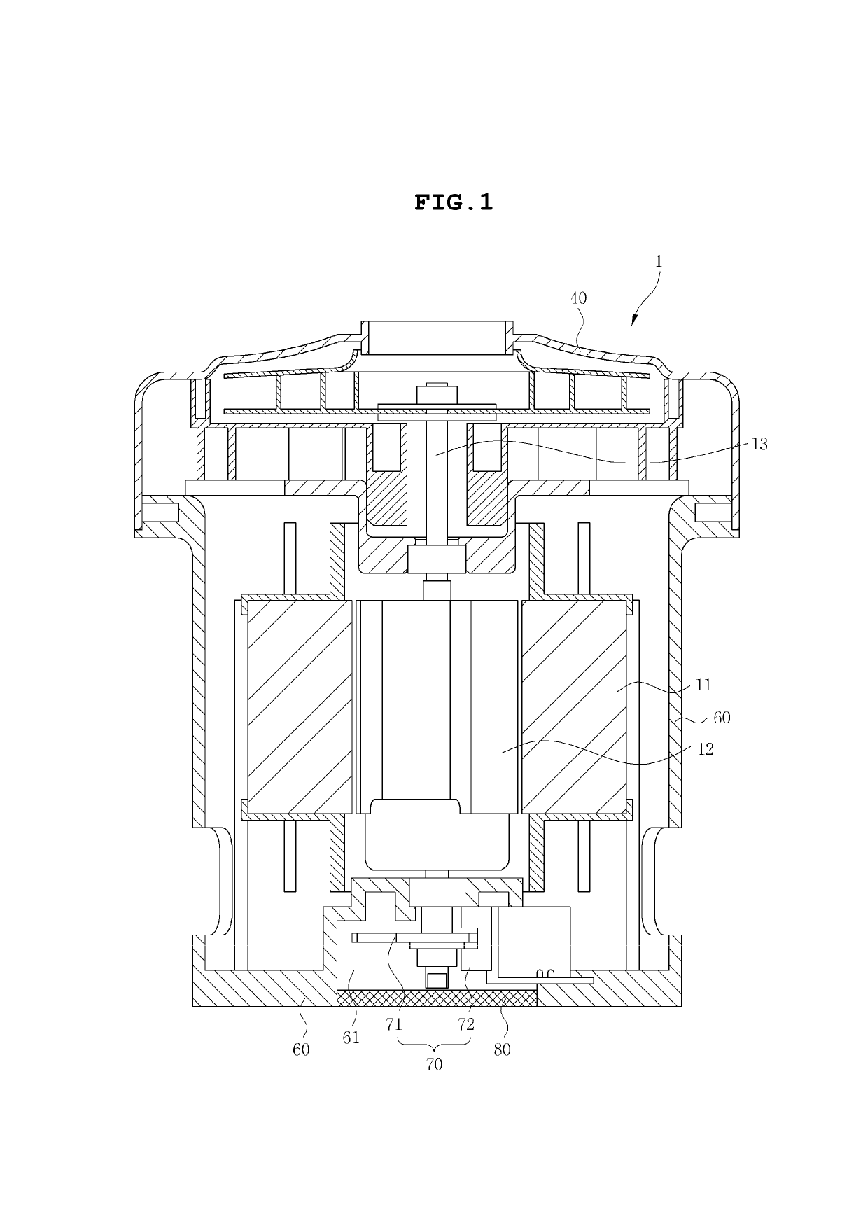

FIG. 1 is a cross-sectional view of a switched reluctance motor according to a preferred embodiment of the present invention.

As shown in FIG. 1, the switched reluctance motor 1 according to the preferred embodiment of the present invention is configured to include a stator 11, a rotor 12, a motor shaft 13, a housing 60, and a sensor part 70.

In addition, the motor shaft 13 generates suction force by means of an impeller coupled thereto so as to rotate integrally with the motor shaft 13 at an upper portion of the rotor 12. A diffuser is arranged at the outside of the impeller by a predetermined interval so as to enable rotation of the impeller and guides air sucked by rotation of the impeller to an internal portion of the motor 1. As widely known in those skilled in the art, the impeller and the diffuser is covered with a casing 40 having a suction hole formed at a central portion thereof, and this casing is coupled onto the housing 60 to protect the internal portion of the motor 1.

The rotor 12 includes a core made of a metal material and a plurality of rotor salient poles. In addition, a central portion of the core is formed with a hollow hole, and the motor shaft 13 is fixedly installed to the hollow hole.

The plurality of rotor salient poles protrude along an outer peripheral surface of the rotor core.

The stator 11 includes a stator yoke made of a metal material and a plurality of stator salient poles. The stator yoke has an entirely cylindrical shape so as to form a hollow hole having an inner diameter larger than an outer diameter of the rotor 12 so that the rotor is rotatably received therein.

In addition, the plurality of stator salient poles protrude from an inner peripheral surface of the stator yoke so as to face the rotor salient poles and include coils wound therearound several times in order to receive power from the outside.

As shown in FIG. 1, the housing 60 is formed in a cup shape in which an upper portion thereof is opened, a lower surface of the housing 60 is formed with an opening part through which the motor shaft 13 penetrates, and a side wall of the housing 60 is provided with at least one outlet. Through the outlet, air sucked into the motor by means of the impeller may be discharged to the outside of the motor. Here, the sucked air is discharged to the outside, such that heat in the motor may be emitted to the outside.

As shown in FIG. 1, the housing 60 has the cup shape in which the upper portion thereof is opened, but the casing 40 has an upside-down cup shape in which a lower portion thereof is opened. The housing 60 and the casing 40 may protect the internal portion of the motor.

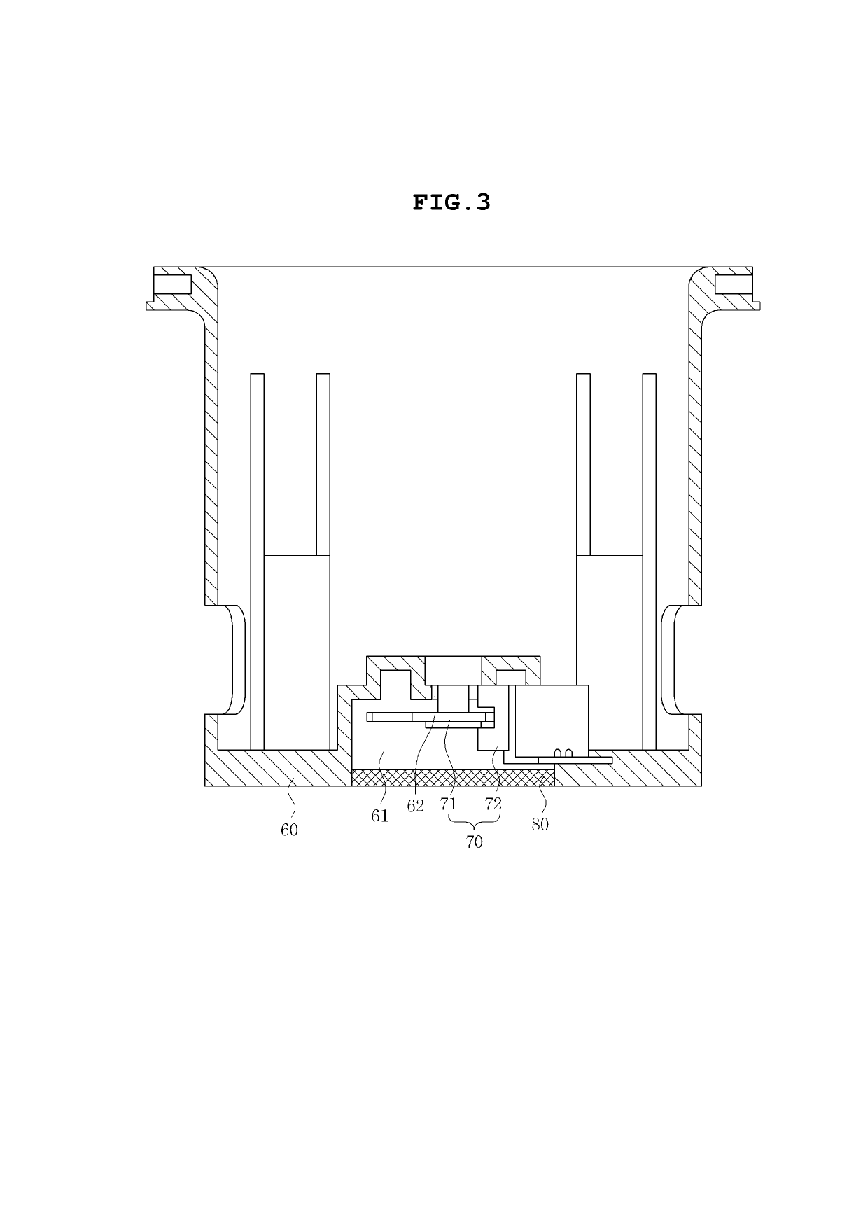

As described above, a lower portion of the motor shaft 13 penetrates through the opening part 62 (See FIG. 3). The outside of the motor housing 60, more specifically, the motor shaft 13 protruding from the lower surface of the motor housing 60 is coupled to a disk 71.

As widely known, the disk 71 has the same shape as that of a cross-section of the rotor perpendicular to an axial direction of the motor shaft 13. A circumferential surface of the rotor 12 is formed to be convex and concave, and similarly, the disk 71 is formed to have the salient pole shape. The disk 71 is coupled to the motor shaft 13 to receive rotational force of the motor shaft 13, such that the disk 71 may rotate on a sensor 72.

The sensor part 70 provided in the switched reluctance motor 1 according to the present invention is configured of the disk 71 and the sensor 72, and an exposed portion of the sensor part is shielded by a filter 80 as shown in FIG. 8.

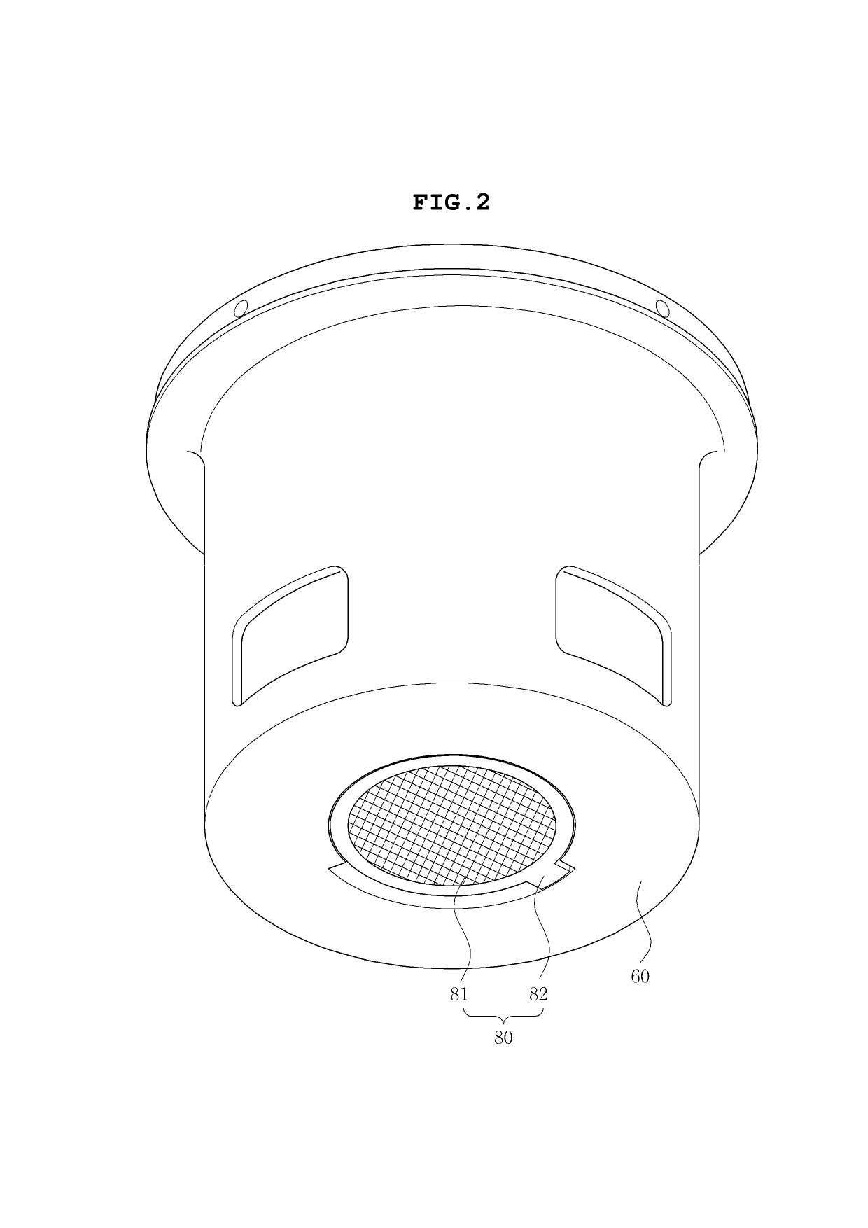

The sensor part 70, particularly, the filter 80 will be described in detail with reference to FIG. 2.

This sensor part 70 is exposed to the outside, such that the sensor pat 70 is exposed to impact from the outside as it is and does not detect rotation of the rotor, and foreign materials such as dust, or the like, may be introduced in the motor through the opening part, which is a through path of the motor shaft 13 assisting in rotation of the disk of the sensor part.

As another example, in the switched reluctance motor 1 according to the present invention, the housing 60 of the motor 1 includes a receiving groove 61 so that the sensor part 70 may be installed to be separated from a dusty internal portion of the motor 1, for example, an internal portion of the housing 60 and be protected from external impact.

Preferably, the receiving groove 61 may be formed to be concave at the lower surface of the housing 60 and protrude toward the internal portion of the motor. More preferably, the center of the receiving groove 61 is coaxial with the motor shaft, such that rotational driving of the motor cannot be affected.

In addition, an opening part through which the motor shaft may enter is punched at a central portion of the receiving groove 61.

As shown in the accompanying drawings, the motor shaft 13 passes through the lower surface of the housing 60, that is, the opening part 62 (See FIG. 3) punched at the receiving groove 61 to be extended up to an internal space of the receiving groove 61.

The receiving groove 61 supports the disk 71 and the sensor 72 configuring the sensor part 70 to allow the disk 71 or the senor 72 not to protrude under the lower surface of the housing 60, thereby making it possible to significantly protect the sensor part from the external impact.

FIG. 2 is a perspective view of the switched reluctance motor shown in FIG. 1 when viewed from below; and FIG. 3 is a cross-sectional view showing only some components of the switched reluctance motor shown in FIG. 1. By the way, in order to shown an accurate position of the filter, other components except for the motor housing and the filter are not shown.

As shown in FIG. 1, the sensor part 70 is mounted in the receiving groove 61 of the housing 60 so as to be protected from impact applied from an upper portion thereof or a side thereof. However, a lower portion of the sensor part 70 is exposed as it is.

To this end, the switched reluctance motor according to the present invention further includes the filter 80 at the lower surface of the housing 60 so as to prevent the sensor part 70 from contacting dust.

This filter 80 closes an opened lower end of the receiving groove 61 to allow the lower portion of the sensor part 70 not to be directly exposed. Here, the filter may have a flat disk shape so as to close the opened part of the lower portion of the receiving groove and correspond to the cylindrical receiving groove, and as needed, the filter may have a cup shape (not shown) so as to enclose the sensor part exposed as it is at the lower portion of the motor not including the receiving groove.

Preferably, the filter 80 has a mesh structure. When the sensor part 70 is completely sealed, a degree of vacuum in the receiving groove 61 receiving the sensor part 70 may be increased by the rotational driving of the motor. In addition, an internal temperature of the receiving groove 61 may be increased.

Therefore, the filter 80 needs to have a mesh structure so as to smoothly supply air to the internal portion of the receiving groove 61.

The filter 80 has the same shape and size as those of the opened part of the lower portion of the receiving groove 61, such that the filter 80 may be easily mounted on and/or separated from the opened part of the lower portion of the receiving groove 61.

To this end, the filter may include a screen 81 and a flange 82 provided at an edge of the screen 81.

The screen 81 has a mesh structure to provide a dustproof effect or dust collection effect and enables inflow and outflow of air. In other words, fine pores of the screen 81 facilitates entry of air into the receiving groove 61, thereby making it possible to reduce the degree of vacuum in the receiving groove of the switched reluctance motor and suppress the temperature from being increased.

The screen 81 has fine pores to provide the dustproof effect as described above, and the flange 82 assists so as to be easily coupled to an inner peripheral surface of the receiving groove 61.

For example, the flange 82 may be provided at the edge of the screen 81 or formed in a ring shape at an outer peripheral surface of the screen 81.

This flange 82 may be coupled to the inner peripheral surface of the receiving groove 61 by a press-fitting method, a snap method, or a screw fastening method, so as to be seated thereon, but is not limited thereto. That is, the flange 82 may be fixedly coupled by various methods.

More preferably, the filter 80 according to the present invention may be made of an insulating material, and be made of a synthetic resin for lightness. Since electric force and magnetic force may remain due to the motor characteristics, the filter 80 needs to be made of the insulating material so as not to be affected by electric force and magnetic force.

The filter 80 according to the present invention may include the screen 81 and the flange 82 that are selectively made of synthetic resins and further include a filter paper such as a non-woven fabric on the screen 81. Double dustproof action is performed through the screen 81 having fine pores and the filter paper (not shown), such that a contact opportunity between dust and the sensor part may be significantly reduced.

As set forth above, the present invention may provide a switched reluctance motor capable of minimizing contact opportunity with dust in the sensor part mounted on the motor housing using the filter.

In addition, according to the present invention, inflow and outflow of air in the sensor part mounted in the receiving groove is permitted, such that a temperature as well as a degree of vacuum are lowered, thereby making it possible to improve durability of the motor.

Further, the filter according to the present invention is made of an insulating material, such that dust cannot be affected by electromagnetic force of the motor.

Furthermore, the filter according to the present invention may be appropriately used in the vacuum cleaner for miniaturization and thinness.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A switched reluctance motor comprising:
a stator;
a rotor rotating based on a motor shaft with respect to the stator;
a housing having a cup shape and receiving the stator and the rotor therein;
a sensor part including a disk coupled to a predetermined position of a lower portion of the motor shaft and a sensor detecting a rotational state of the disk, and mounted on the outside of the housing; and
a filter shielding the sensor part.

2. The switched reluctance motor as set forth in claim 1, wherein the sensor part is disposed under a lower surface of the housing.

3. The switched reluctance motor as set forth in claim 1, wherein the filter has a mesh structure.

4. The switched reluctance motor as set forth in claim 1, wherein the filter includes a screen having a mesh structure with fine pores and a flange provided at an edge of the screen.

5. The switched reluctance motor as set forth in claim 1, wherein the filter is made of an insulating material.

6. The switched reluctance motor as set forth in claim 1, wherein the filter further includes a filter paper.

7. A switched reluctance motor comprising:
a stator;
a rotor rotating based on a motor shaft with respect to the stator;
a housing having a cup shape in which the stator and the rotor are received and including a receiving groove at a central portion of a lower portion thereof;
a sensor part including a disk coupled to a predetermined position of a lower portion of the to motor shaft extended up to the receiving groove and a sensor detecting a rotational state of the disk, and mounted in the receiving groove of the housing; and
a filter shielding the sensor part.

8. The switched reluctance motor as set forth in claim 7, wherein the filter closes an opened part of a lower portion of the receiving groove.

9. The switched reluctance motor as set forth in claim 7, wherein the filter has a flat disk shape.

10. The switched reluctance motor as set forth in claim 7, wherein the filter has a mesh structure.

11. The switched reluctance motor as set forth in claim 7, wherein the filter includes a screen having a mesh structure with fine pores and a flange provided at an edge of the screen.

12. The switched reluctance motor as set forth in claim 7, wherein the filter is made of an insulating material.

13. The switched reluctance motor as set forth in claim 7, wherein the filter further includes a filter paper.
